(19) United States
(12) Patent Application Publication
(10) Pub. No.: US 2012/0285977 A1
(43) Pub. Date: Nov. 15, 2012

(54) Product Dispensing System

(76) Inventors: Aaron L. Bates, Moseley, VA (US); John Gelardi, Midolothian, VA (US); Laurel Thomas, Portland, OR (US)

(21) Appl. No.: 13/306,065

(22) Filed: Nov. 29, 2011

Related U.S. Application Data
(63) Continuation-in-part of application No. 13/105,395, filed on May 11, 2011.

(51) Int. Cl. B65G 59/06; B65D 83/00

(52) U.S. Cl. 221/1; 221/97

(57) ABSTRACT

A product dispensing system including a dispenser frame having a front end longitudinally opposed from a rear end, the dispenser frame including a support deck extending at least partially between the front end and the rear end, the support deck having an upper surface and defining a channel below the upper surface, the channel having an entrance opening and an exit opening, and a product display area positioned below the support deck, and a catch element connected to the dispenser frame proximate the entrance opening.

### PRIORITY

This application is a continuation-in-part of U.S. Ser. No. 13/105,395 filed on May 11, 2011, the entire contents of which are incorporated herein by reference.

### FIELD

This application relates to the dispensing of products from packaging containers and, more particularly, to product dispensers configured to cooperate with packaging containers to dispense products.

### BACKGROUND

Products are typically shipped to retailers in bulk by enclosing multiple individual product units in a container, such as a carton or box. For example, canned foods may be shipped to a retailer in a box containing twenty-four individual cans. Then, it is typically the retailer's obligation to remove the individual product units from the container and present them to consumers.

Alternatives to the traditional package-ship-unpack-display model are being developed in an effort to improve operating efficiency. For example, U.S. Pat. No. 7,922,437 to Lofton et al. discloses a new system for dispensing and displaying products packaged in a container. Specifically, the system includes a frame having a support structure, a product display area and an opening tool. The frame may be positioned on a retailer's shelf and loaded with product simply by placing a container comprising multiple units of product onto the support structure of the frame. As the container is being placed onto the support structure, the opening tool of the frame opens the container in such a manner that products roll from the container and down to the product display area of the frame under the force of gravity.

As another example, U.S. patent application Ser. No. 13/032,734 filed by Gelardi et al. discloses a product dispensing system that utilizes an opening tool having a catch element that engages and opens a container as the container is loaded onto the dispenser, and then guides the container to avoid interference between the dispensing products and the open container.

Despite advances already made in the field, those skilled in the art continue with research and development efforts directed to apparatus and systems for dispensing products from packaging containers.

### SUMMARY

In one aspect, the disclosed product dispensing system may include a dispenser frame having a front end longitudinally opposed from a rear end, the dispenser frame including a support deck extending at least partially between the front end and the rear end, the support deck having an upper surface and defining a channel below the upper surface, the channel having an entrance opening and an exit opening, and a product display area positioned below the support deck, and a catch element connected to the dispenser frame proximate the entrance opening.

In another aspect, the disclosed product dispensing system may include a dispenser frame having a front end longitudinally opposed from a rear end, the dispenser frame including an upper support deck extending at least partially between the front and rear ends and having an upper surface and defining a channel below the upper surface, the channel having an entrance opening and an exit opening, wherein the exit opening opens toward the rear end of the dispenser frame, a lower support deck positioned below the upper support deck, the lower support deck defining a product display area, wherein the dispenser frame defines an opening sized to allow product passage from the upper support deck down to the lower support deck, a catch element connected to the dispenser frame proximate the entrance opening of the channel, and a container that defines an internal volume and an access opening into the internal volume, the container being positioned on the upper support deck such that the access opening is aligned with the opening defined by the dispenser frame, wherein a portion of the container extends through the channel.

In yet another aspect, disclosed is a method for dispensing products from a container using a dispenser. The method may include the steps of (1) providing a dispenser including a frame having a front end longitudinally opposed from a rear end, the frame including an upper support deck having an upper surface and extending at least partially between the front end and the rear end, and a lower support deck positioned below the upper support deck, the lower support deck defining a product display area, wherein the frame defines a first opening, and a catch element connected to the frame; (2) providing a container that initially houses a plurality of products; (3) forming an initiation opening in the container; (4) urging the container along the upper support deck from the front end toward the rear end such that the catch element engages the initiation opening and separates an access panel from the container to form a second opening, the separated access panel being directed below the upper surface and toward the rear end; and (5) aligning the second opening with the first opening such that at least one product of the plurality of products moves from the container to the product display area, wherein the product interacts with the separated access panel as the product moves to the product display area.

Other aspects of the disclosed product dispensing system will become apparent from the following detailed description, the accompanying drawings and the appended claims.

### BRIEF DESCRIPTION OF THE DRAWINGS

FIG. 1 is a front and side perspective view of one aspect of the disclosed product dispensing system;

FIG. 2A is a bottom and side perspective view of the container of the product dispensing system of FIG. 1;

FIG. 2B is a bottom and side perspective view of the container of FIG. 2A, shown with an initiation opening formed therein;

FIG. 3 is a side and bottom perspective view of the container of FIG. 2B, shown in an opened configuration;

FIG. 4 is a top plan view of a container blank that may be used to form the container of FIG. 2A;

FIG. 5 is a side elevational view, in section, of the dispenser of the product dispensing system of FIG. 1;

FIG. 6 is a side elevational view, in section, of the dispenser of FIG. 5, shown with the container in a first, partially loaded configuration;

FIG. 7 is a side elevational view, in section, of the dispenser of FIG. 6, shown with the container in a second, fully loaded configuration; and

FIG. 8 is a side elevational view, in section, of the dispenser of FIG. 7, shown with the container in a third, dispensing configuration.

### DETAILED DESCRIPTION

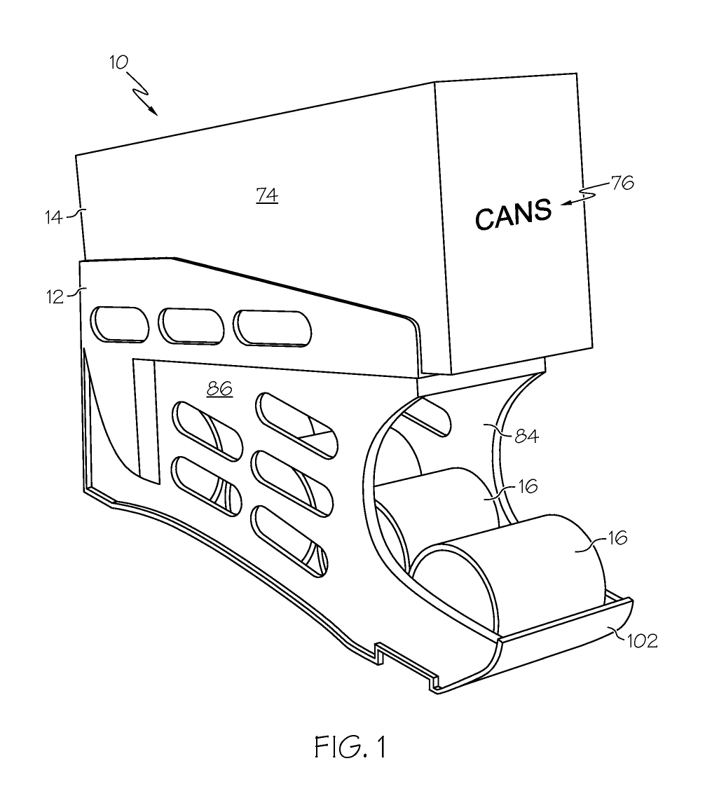

Referring to FIG. 1, one aspect of the disclosed product dispensing system, generally designated 10, may include a dispenser 12 and a container 14. The container 14 may house multiple units of product 16. The container 14 may be loaded onto the dispenser 12 by urging the container 14 generally horizontally along the dispenser 12. As the container 14 is urged along the dispenser 12, the dispenser 12 may engage and open the container 14, thereby releasing the products 16 from the container 14 to the dispenser 12 without the container 14 interfering with movement of the products 16 from the container 14 and through the dispenser 12.

The container 14 may be any container capable of housing products 16 and beneficially interacting with the disclosed dispenser 12. For example, the container 14 may be a paperboard carton or a corrugated box.

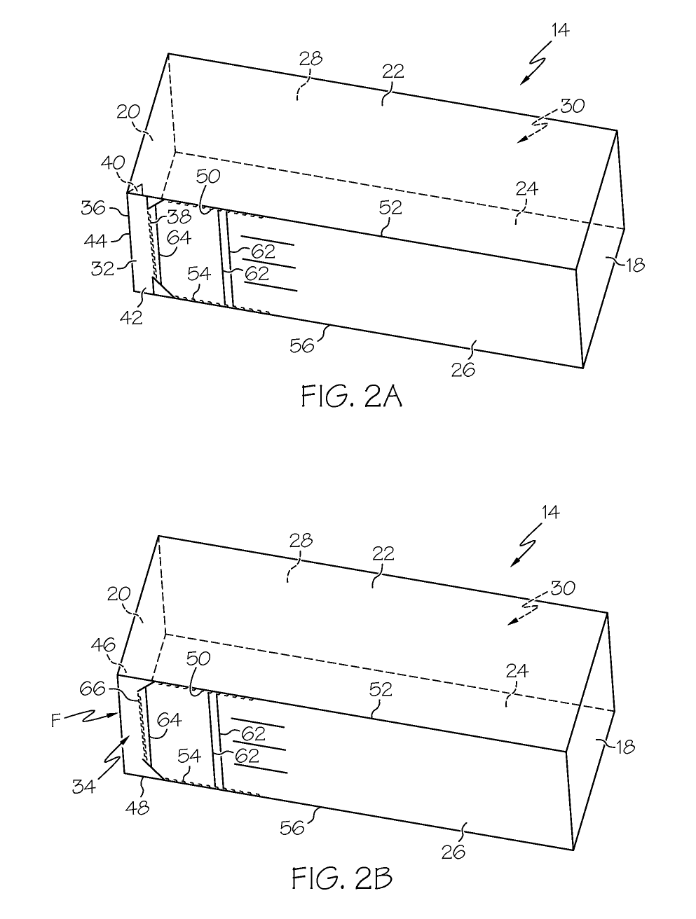

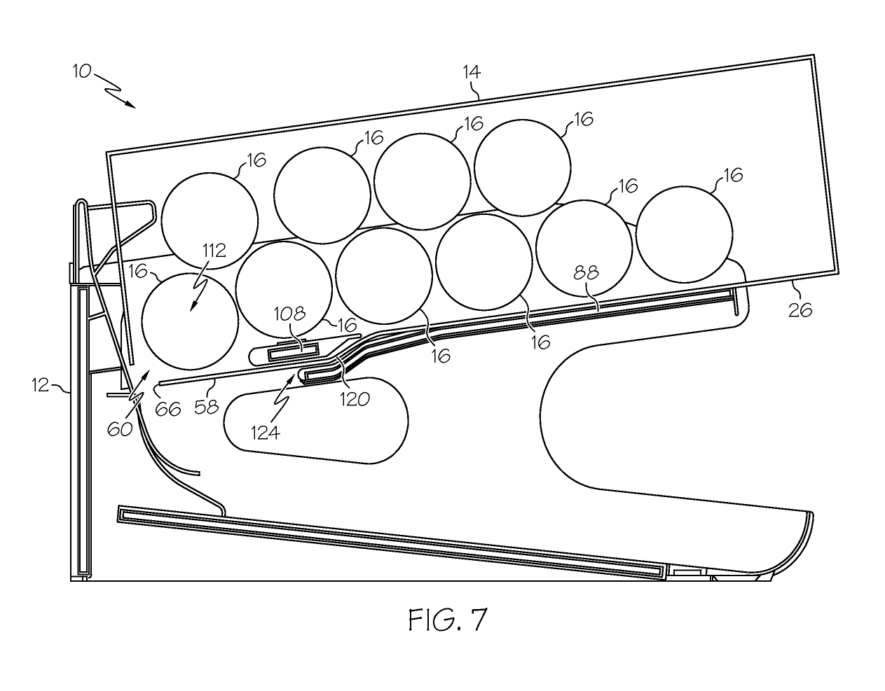

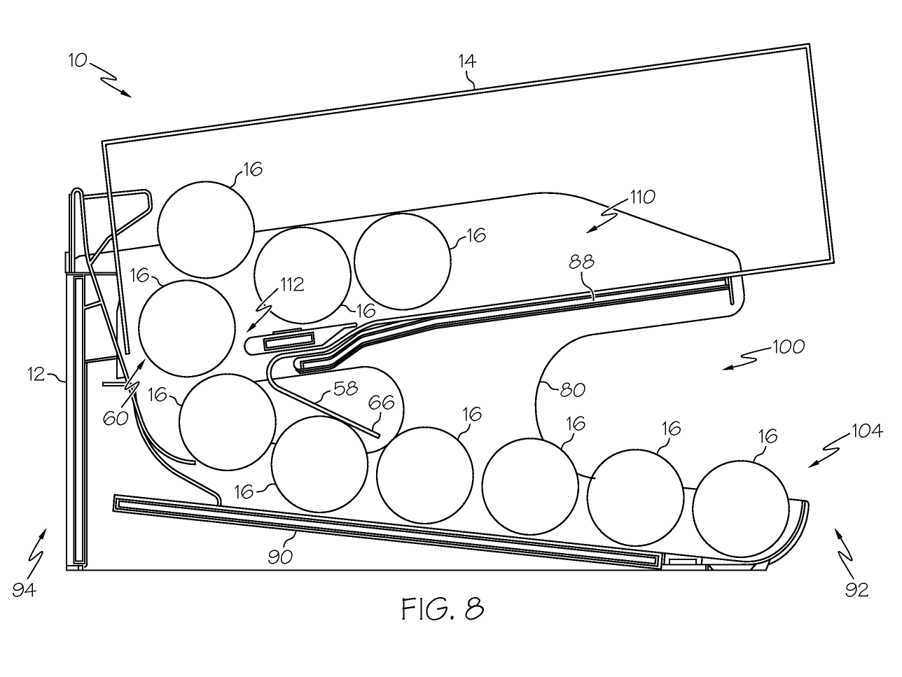

Referring to FIG. 2A, the container 14 may be a generally rectilinear container having six walls 18, 20, 22, 24, 26, 28 that define an internal volume 30 for receiving the products 16 (FIGS. 7 and 8). Opposed walls 18 and 20 may define the front and rear walls, respectively, of the container 14. Opposed walls 22 and 24 may define the first (e.g., left) and second (e.g., right) side walls, respectively, of the container 14. Opposed walls 26 and 28 may define the base and upper walls, respectively, of the container 14.

In a first construction, the base wall 26 of the container 14 may include a removable priming feature 32, as shown in FIG. 2A. As shown in FIG. 2B, the removable priming feature 32 may be removed from the container 14 to reveal an initiation opening 34 that opens into the internal volume 30 of the container 14. The removable priming feature 32 may be positioned such that the initiation opening 34 is formed proximate (i.e., at or near) the rear wall 20 of the container 14, such as along the edge 44 between the base wall 26 and the rear wall 20.

Referring to FIG. 2A, the removable priming feature 32 (FIG. 2A) may be a zipper strip or the like, and may be defined by two parallel, laterally extending rows of perforations 36, 38 and two parallel, longitudinally extending rows of perforations 40, 42. Weakening features other than perforations may also be used.

Thus, prior to loading the container 14 onto the dispenser 12, a user may remove the removable priming feature 32 from the container 14, such as by tearing the removable priming feature 32 from the container 14 along the rows of perforations 36, 38, 40, 42, thereby forming the initiation opening 34, as shown in FIG. 2B.

In a second construction, the initiation opening 34 may be pre-formed in the base wall 26 of the container 14. Optionally, a peelable label or the like (not shown) may be applied to the container 14 over the pre-formed initiation opening 34. Therefore, the initiation opening 34 may be revealed by peeling away the optional peelable label from the container 14.

Referring to FIG. 2B, the initiation opening 34 may extend generally laterally between the side walls 22, 24 of the container 14. For example, the initiation opening 34 may include a first (e.g., left) end 46 positioned proximate the left side wall 22 of the container 14 and a second (e.g., right) end 48 positioned proximate the right side wall 24 of the container 14.

Those skilled in the art will appreciate that the initiation opening 34 may be positioned at various alternative locations and may have various alternative configurations, provided that the initiation opening 34 is capable of being engaged by the dispenser 12 when the container 14 is being loaded onto the dispenser 12. As a first alternative implementation, the initiation opening 34 may be formed in the rear wall 20 of the container 14. As a second alternative implementation, the initiation opening 34 may be formed in the base wall 26, between the front 18 and rear 20 walls of the container 14. Other implementations are also contemplated.

A first weakening feature 50 may generally longitudinally extend from the initiation opening 34 toward the front wall 18 of the container 14. The first weakening feature 44 may be formed in the base wall 26 proximate the edge 52 between the base wall 26 and the left side wall 22.

A second weakening feature 54 may generally longitudinally extend from the initiation opening 34 toward the front wall 18 of the container 14, and may be laterally spaced from the first weakening feature 50. The second weakening feature 54 may be formed in the base wall 26 proximate the edge 56 between the base wall 26 and the right side wall 24.

The longitudinal length of the first and second weakening features 50, 54 may be dictated by the size (e.g., the diameter) of the products 16 housed in the container 14. As one example, the first and second weakening features 50, 54 may extend along at least 5 percent of the length of the edge 52. As another example, the first and second weakening features 50, 54 may extend along at least 10 percent of the length of the edge 52. As another example, the first and second weakening features 50, 54 may extend along at least 20 percent of the length of the edge 52. As yet another example, the first and second weakening features 50, 54 may extend along at least 30 percent of the length of the edge 52.

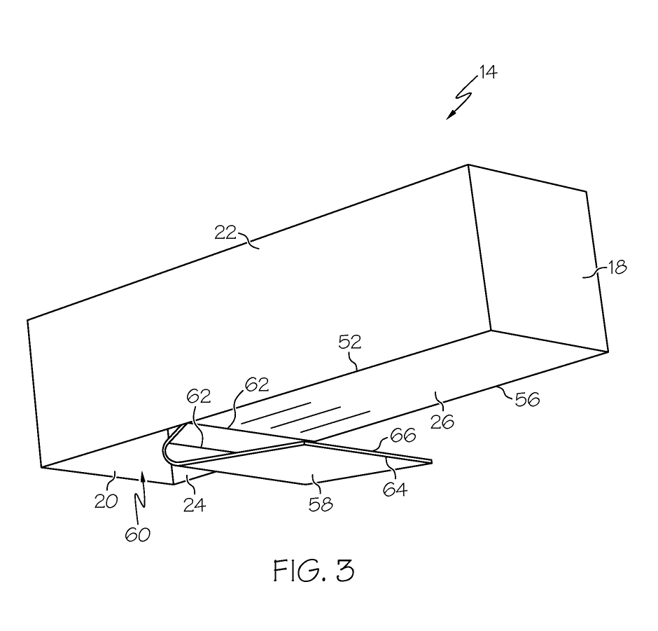

The first and second weakening features 50, 54 may facilitate the separation of a portion of the base wall 26 from the rest of the container 14, as shown in FIG. 3. In a first implementation, the first and second weakening features 50, 54 may be formed as rows of perforations. For example, the first and second weakening features 50, 54 may be formed as rows of standard perforations, as rows of micro perforations or as rows of zipper-like cuts. In a second implementation, the first and second weakening features 50, 54 may be formed by scoring the container 14. In a third implementation, the first and second weakening features 50, 54 may be formed by creasing the container 14. Other techniques useful for forming the first and second weakening features 50, 54 will become apparent to those skilled in the art.

Thus, a force F (FIG. 2B) applied to the base wall 26 at the initiation opening 34 may partially separate a portion of the base wall 26 from the container 14 along the first and second weakening features 50, 54 to form an access panel 58, as shown in FIG. 3. As the access panel 58 is separated from the remainder of the container 14, the size of the initiation opening 34 may be significantly increased, thereby forming an access opening 60 in the container 14. The access opening 60 may allow the products 16 housed in the container 14 to be dispensed from the container 14 and, ultimately, into the dispenser 12 when the container 14 is loaded on the dispenser 12.

In a first optional implementation, one or more preformed fold lines 62 may laterally extend across the base wall 26 to encourage the access panel 58 to pivot relative to the base wall 26 of the container 14. Preformed fold lines 62 may reduce or eliminate the possibility that the access panel 58 will randomly fold or bunch-up as the access panel 58 is formed.

In a second optional implementation, a preformed fold line 64 may be formed proximate the rear edge 66 of the base wall 26, and may laterally extend across the base wall 26. Preformed fold line 64 may encourage the rear edge 66 of the base wall 26 to pivot downward (i.e., away from the internal volume 30 of the container 14), thereby potentially enhancing the ability of the dispenser 12 to engage the rear edge 66 of the base wall 26 and separate the access panel 58 from the container 12.

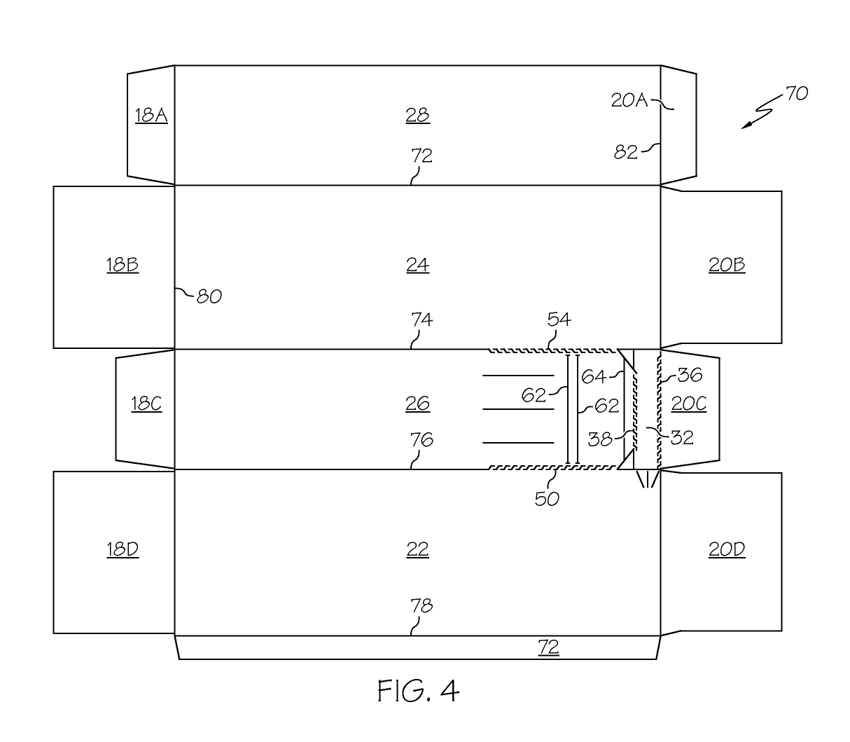

The container 14 may be formed from a paperboard container blank, such as the paperboard container blank 70 shown in FIG. 4. The container blank 70 may include a plurality of pre-formed fold lines 72, 74, 76, 78, 80, 82 that define the front wall 18 (comprised of front wall panels 18A, 18B, 18C and 18D), the rear wall 20 (comprised of rear wall panels 20A, 20B, 20C and 20D), the right side wall 22, the left side wall 24, the base wall 26, the upper wall 28 and sealing panel 72.

The container 14 may be assembled by folding the container blank 70 along the longitudinal fold lines 72, 74, 76, 78 and connecting the upper wall 28 to the sealing panel 72 to form the three-dimensional body of the container 14. Then, the front wall panels 18A, 18B, 18C, 18D may be assembled to form the front wall 18 of the container 14. Finally, the rear wall panels 20A, 20B, 20D, 20D may be assembled to form the rear wall 20 of the container 14.

The container blank 70 may be formed from a paperboard-based material, such as C1S paperboard, which may have a coating (e.g., clay) on a first major surface thereof, which may form the outer surface 74 (FIG. 1) of the container 14, and an uncoated second major surface. As another example, the paperboard-based material may be C2S paperboard, which may have a coating (e.g., clay) on both major surfaces thereof. Optionally, at least one major surface of the container blank may be marked with various indicia 76 (FIG. 1), such as printed text and/or graphics.

While a specific paperboard container blank 70 is shown and described, those skilled in the art will appreciate that various techniques and materials may be used to form the container 14. Folded paperboard containers are only one specific and non-limiting example of the disclosed container 14.

Various products 16 having various shapes and configurations may be housed in the container 14 and dispensed by the disclosed product dispensing system 10. Suitable products 16 include cans (e.g., canned soup or pet food), jars (e.g., jarred sauce) or bottles (e.g., bottled soft drinks).

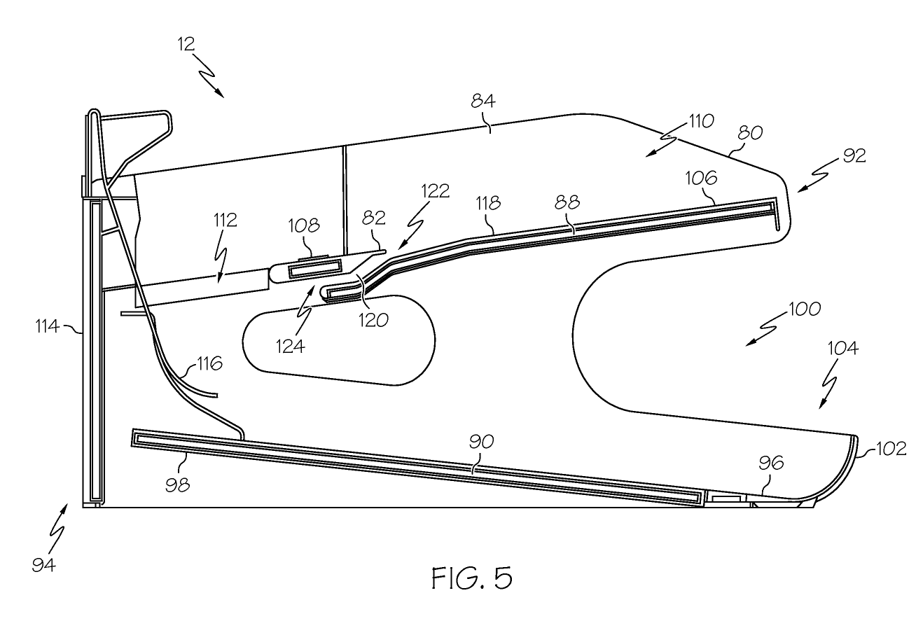

Referring to FIG. 5, the dispenser 12 may include a frame 80 and a catch element 82. The frame 80 of the dispenser 12 may support the container 14 in a desired configuration, such as a slightly declined, but generally horizontal configuration, as shown in FIGS. 1, 7 and 8. As the container 14 is generally horizontally urged along the dispenser 12 to the configuration shown in FIGS. 1, 7 and 8, the catch element 82 may engage the initiation opening 34 (FIG. 2B) in the container 14 to separate the access panel 58 (FIG. 3) from the container 14, as is described in greater detail herein.

The frame 80 may include a first (e.g., right) side wall 84, a second (e.g., left) side wall 86, an upper support deck 88 and a lower support deck 90. The right side wall 84 may be laterally spaced from the left side wall 86, and may be generally parallel with the left side wall 86. The frame 80 may include a first (e.g., front) end 92 and a second (e.g., rear) end 94 longitudinally opposed from the first end 92.

The lower support deck 90 may laterally extend between the right 84 and left 86 side walls, and may include a front end 96 that longitudinally extends toward the front end 92 of the frame 80 and a rear end 98 that longitudinally extends toward the rear end 94 of the frame 80. Therefore, the lower support deck 90 and the side walls 84, 86 may define a lower level 100 of the frame 80.

The lower support deck 90 may be inclined from the front end 96 to the rear end 98 (i.e., the rear end 98 may be elevated relative to the front end 96) such that products 16 deposited proximate the rear end 98 of the lower support deck 90 roll down to the front end 96 of the lower support deck 90 under the force of gravity. The extent of the incline of the lower support deck 90 may be dictated by, among other things, the coefficient of friction of the material used to form the frame 80 and the shape of the products 16 to be dispensed by the dispenser 12.

A stop 102 may be positioned proximate the front end 96 of the lower support deck 90 to prevent products 16 from rolling beyond the front end 96 of the lower support deck 90. For example, the stop 102 may be connected to (e.g., integral with) the lower support deck 90, and may form an upward curve at the front end 96 of the lower support deck 90. Therefore, the stop 102 may collect products 16 at the front end 96 of the lower support deck 90, thereby defining a product display area 104 at the front end 96 of the lower support deck 90.

The upper support deck 88 may laterally extend between the right 84 and left 86 side walls, and may include a front end 106 that longitudinally extends toward the front end 92 of the frame 80 and a rear end 108 that longitudinally extends toward, but not to, the rear end 94 of the frame 80. Therefore, the upper support deck 88 and the side walls 84, 86 may define an upper level 110 of the frame 80.

The spacing between the rear end 108 of the upper support deck 88 and the rear end 94 of the frame 80 may define an opening 112, which may function as a chute to allow products 16 to move from the upper level 110 to the lower level 100 of the frame 80. When the container 14 is in the fully loaded configuration on the dispenser 12, as shown in FIGS. 7 and 8, the access opening 60 (FIG. 3) in the container 14 may be aligned with the opening 112 (FIG. 5) defined by the frame 80.

The upper support deck 88 may be declined from the front end 106 to the rear end 108 (i.e., the front end 106 may be elevated relative to the rear end 108). Therefore, products 16 supported on the upper support deck 88 may roll under the force of gravity down to the rear end 108 of the upper support deck 88, through the opening 112, to the lower level 100 of the frame 80 and, ultimately, to the product display area 104.

An optional rear wall 114 may be positioned proximate the rear end 94 of the frame 80 between the right 84 and left 86 side walls. The rear wall 114 may serve as a stop that inhibits rearward horizontal movement of the container 14 (FIG. 1) along the upper support deck 88 beyond the rear wall 114.

A guide 116 may be connected to the rear wall 114 of the frame 80, and may extend through the opening 112 in the frame 80, from the upper level 110 to the lower level 100. The guide 116 may be a ramp-like structure, and may be positioned to receive products 16 exiting the container 14 and passing through the opening 112 in the frame 80, and may guide the products 16 to the rear end 98 of the lower support deck 90.

The catch element 82 may be positioned between the front end 106 and the rear end 108 of the upper support deck 88. For example, the catch element 82 may be positioned proximate the rear end 108 of the upper support deck 88.

The catch element 82 may laterally extend between the side walls 84, 86 of the frame 80, and may longitudinally protrude toward the front end 82 of the frame 80. The specific size and shape of the catch element 82 may depend on the size and shape of the initiation opening 34 in the container 14.

In an effort to minimize interference between the catch element 82 and the container 14 during loading, the catch element 82 may be substantially co-planar with the upper surface 118 of the upper support deck 88. However, those skilled in the art will appreciate that slight displacement and/or a slight angle of the catch element 82 relative to the upper surface 118 of the upper support deck 88 may encourage engagement of the initiation opening 34 in the container 14 by the catch element 82 during loading of the container 14 onto the dispenser 12.

While the catch element 82 is shown and described as a generally flat, laterally elongated and forwardly extending protrusion, those skilled in the art will appreciate that various alternative structures may be used as the disclosed catch element 82 without departing from the scope of the present disclosure. For example, suitable catch elements may include various hooks, protrusions, flanges, detents and the like sufficient to engage the initiation opening 34 in the container 14 and separate the access panel 58 from the base wall 26 of the container 14.

The upper support deck 88 may define a channel 120 positioned to guide the access panel 58 below the upper surface 118 of the upper support deck 88 as the access panel 58 is separated from the container 14 by the catch element 82. The channel 120 may extend from an entrance opening 122 proximate the catch element 82, down below the catch element 82 and, ultimately, to an exit opening 124. The exit opening 124 may open toward the rear end 94 of the frame 80. The channel 120 may laterally extend between the side walls 84, 86 of the frame 80, and may have a lateral width sufficient to allow the access panel 58 (FIG. 3) to pass therethrough.

Thus, the catch element 82 may engage the initiation opening 34 (FIG. 2B) in the container 14 and may separate the access panel 58 (FIG. 3) from the container 14 as the container 14 is moved horizontally along the upper support deck 88 toward the rear end 94 of the frame 80. The shape and position of the catch element 82 may be configured such that a portion of the catch element 82 extends through the initiation opening 34 (FIG. 2B) in the container 14. Therefore, as the container 14 moves relative to the catch element 82, the catch element 82 may urge the base wall 26 downward through the opening 122 and into the channel 120, thereby causing separating of the access panel 58 (FIG. 3) from the container 14 along the first and second weakening features 50, 54 (FIG. 2B) and, ultimately, the formation of the access opening 60 (FIG. 3) in the container 14.

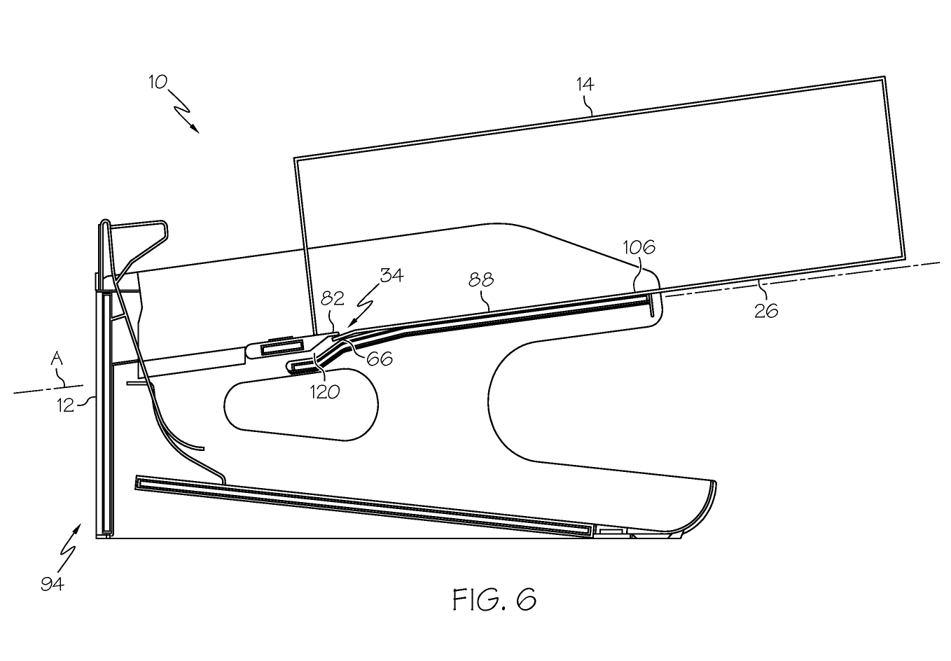

FIGS. 6-8 illustrate the container 14 being loaded onto the dispenser 12 such that the catch element 82 of the dispenser 12 engages and opens the container 14, thereby releasing the products 16 initially housed in the container 14 to the dispenser 12. Specifically, FIGS. 6-8 illustrate the container 14 being urged generally horizontally along the upper support deck 88 (i.e., along the longitudinal axis A of the upper support deck 88) toward the rear end 94 of the dispenser frame 80, thereby automatically opening the container 14 and dispensing the products 16 from the container 14 to the dispenser 12.

As shown in FIG. 6, as the initiation opening 34 in the container 14 approximates the catch element 82 of the dispenser 12, the catch element 82 may pass through the initiation opening 34. With the catch element 82 extending through the initiation opening 34, the rear edge 66 of the base wall 26 of the container 14 may be directed downward through the entrance opening 122 of the channel 120.

As shown in FIG. 7, as the container 14 continues to longitudinally move along the upper support deck 88 toward the rear end 94 of the dispenser 12, the base wall 26 of the container 14 may pass through the channel 120, thereby separating the access panel 58 from the base wall 26. Since the exit opening 124 of the channel 120 opens toward the rear end 94 of the dispenser 12, the separated access panel 58 may be directed toward the rear end 94 of the dispenser 12, thereby partially covering the access opening 60 that has been formed in the container 14.

As shown in FIG. 8, with the container 14 fully loaded onto the dispenser 12, the access opening 60 formed in the container 14 may be aligned with the opening 112 between upper 110 and lower 100 levels of the frame 80. Therefore, the force of gravity may urge the products 16 initially housed in the container 16 through the access opening 60 in the container 14, through the opening 112 in the frame 80, down to the lower support deck 90 and, ultimately, to the product display area 104. The weight of the products 16 passing through the openings 60, 112 may urge the access panel 58 from the configuration shown in FIG. 7 to the configuration shown in FIG. 8.

As the products 16 exiting the container 14 interact with the access panel 58, the access panel 58 may become “hooked” onto the upper support deck 88 of the dispenser 12. Specifically, as the products 16 exiting the container 14 interact with the access panel 58, a first portion of the access panel 58 (i.e., the portion of the access panel 58 within the channel 120) may extend toward the rear end 94 of the dispenser frame 80 while a second portion of the access panel 58 (i.e., the portion of the access panel 58 that includes the rear edge 66) may extend toward the front end 92 of the dispenser frame 80, thereby inhibiting separation of the container 14 from the dispenser 12.

Accordingly, the engagement between the products 16 and the access panel 58 that facilitates “hooking” of the access panel 58 onto the dispenser 12 may function as a theft deterrent by inhibiting the quick and easy separation of a loaded container 14 from the dispenser 12.

Although various aspects of the disclosed product dispensing system have been shown and described, modifications may occur to those skilled in the art upon reading the specification. The present application includes such modifications and is limited only by the scope of the claims.

What is claimed is:

1. A product dispensing system comprising:
a dispenser frame having a front end longitudinally opposed from a rear end, said dispenser frame comprising:
a support deck extending at least partially between said front end and said rear end, said support deck having an upper surface and defining a channel below said upper surface, said channel having an entrance opening and an exit opening; and
a product display area positioned below said support deck; and
a catch element connected to said dispenser frame proximate said entrance opening.

2. The product dispensing system of claim 1 further comprising a container positioned on said support deck.

3. The product dispensing system of claim 2 wherein a portion of said container is received in said channel.

4. The product dispensing system of claim 2 wherein said container initially houses a plurality of products.

5. The product dispensing system of claim 1 wherein said exit opening opens toward said rear end of said dispenser frame.

6. The product dispensing system of claim 1 wherein said support deck comprises a front end and a rear end, and wherein said catch element is connected proximate said rear end of said support deck.

7. The product dispensing system of claim 1 wherein said product display area is proximate said front end of said dispenser frame.

8. The product dispensing system of claim 1 wherein said dispenser frame further comprises a lower support deck positioned below said support deck, said lower support deck defining said product display area.

9. The product dispensing system of claim 8 wherein said support deck defines an upper level of said dispenser frame and said lower support deck defines a lower level of said dispenser frame, and wherein said dispenser frame defines an opening between said upper level and said lower level.

10. The product dispensing system of claim 9 further comprising a container supported on said support deck, wherein said container defines an internal volume and an access opening into said internal volume.

11. The product dispensing system of claim 10 wherein said access opening is aligned with said opening defined by said dispenser frame.

12. The product dispensing system of claim 11 wherein a portion of said container is received in said channel.

13. A product dispensing system comprising:
a dispenser frame having a front end longitudinally opposed from a rear end, said dispenser frame comprising:
an upper support deck extending at least partially between said front end and said rear end, said upper support deck having an upper surface and defining a channel below said upper surface, said channel having an entrance opening and an exit opening, wherein said exit opening opens toward said rear end of said dispenser frame;
a lower support deck positioned below said upper support deck, said lower support deck defining a product display area,
wherein said dispenser frame defines an opening sized to allow product passage from said upper support deck down to said lower support deck;
a catch element connected to said dispenser frame proximate said entrance opening of said channel; and
a container that defines an internal volume and an access opening into said internal volume, said container being positioned on said upper support deck such that said access opening is aligned with said opening defined by said dispenser frame, wherein a portion of said container extends through said channel.

14. The product dispensing system of claim 13 wherein said container initially houses a plurality of products.

15. The product dispensing system of claim 14 wherein said plurality of products are at least partially dispensed from said container and supported on said lower support deck.

16. The product dispensing system of claim 15 wherein said portion of said container that extends through said channel is engaged with at least one product of said plurality of products supported on said lower support deck.

17. A product dispensing method comprising the steps of:
providing a dispenser comprising:
a frame having a front end longitudinally opposed from a rear end, said frame comprising an upper support deck having an upper surface and extending at least partially between said front end and said rear end, and a lower support deck positioned below said upper support deck, said lower support deck defining a product display area, wherein said frame defines a first opening; and
a catch element connected to said frame;
providing a container, said container initially housing a plurality of products;
forming an initiation opening in said container;
urging said container along said upper support deck from said front end toward said rear end such that said catch element engages said initiation opening and separates an access panel from said container to form a second opening, said separated access panel being directed below said upper surface and toward said rear end; and
aligning said second opening with said first opening such that at least one product of said plurality of products moves from said container to said product display area, wherein said product contacts said separated access panel as said product moves to said product display area.

18. The method of claim 17 wherein said separated access panel extends through a channel defined by said upper support deck during said urging step.

19. The method of claim 17 wherein said separated access panel releasably engages said frame when said product is in contact with said separated access panel.

20. The method of claim 17 wherein said separated access panel is hooked onto said upper support deck when said product is in contact with said separated access panel.
